(19) United States
(12) Patent Application Publication
(10) Pub. No.: US 2009/0104590 A1
(43) Pub. Date: Apr. 23, 2009

(54) INTERACTIVE BOOK SYSTEM BASED ON ULTRASONIC POSITION DETERMINATION

(76) Inventor: Shih-Chin YANG, Freemont, CA (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/264,445

(22) Filed: Nov. 4, 2008

Related U.S. Application Data
(63) Continuation-in-part of application No. 10/390,271, filed on Mar. 15, 2003.

(51) Int. Cl. G09B 5/00

(52) U.S. Cl. 434/317

(57) ABSTRACT

In an interactive system for interacting with a printed material having at least a visual icon associated with predetermined response data, there is an ultrasonic pointing unit positionable over the at least one visual icon and arranged for generating ultrasonic wave. An ultrasonic positioning base unit is arranged for receiving the ultrasonic wave from the ultrasonic pointing unit and determining a position of the ultrasonic pointing unit based on the received ultrasonic wave. A is arranged for locating, in a data storage, the response data corresponding to the visual icon according to the position of the ultrasonic pointing unit. A response unit is arranged for outputting the response data.

### CROSS-REFERENCE TO RELATED APPLICATION

This application is a continuation in part of U.S. patent application Ser. No. 10/390,271 and is also related to U.S. patent application Ser. No. 11/125,280. The above-identified applications are all incorporated by reference herein in their entirety.

### TECHNICAL FIELD

The disclosure relates generally to the field of electronic entertainment and educational devices and, more specifically, to a method and a device that allow a reader and/or user to interact with printed material such as books.

### BACKGROUND

There are various devices known to the inventor(s) of the present invention as being capable of associating audio and visual output with visual icons on printed material. When a reader points a pointing device on a visual icon such as a word, picture, then the corresponding sound or flashing light will be produced. Those devices have the benefit of making reading a more interactive process, and find their success in various applications. In the case of learning language, when a reader points to a word, the corresponding sound will be pronounced. The key of those devices is to identify where the reader points at. There are currently several systems and methods known to the inventor(s) of the present invention.

In a voice book system described by U.S. Pat. No. 6,064,855, a detecting device which is electrically communicated with the audio device for detecting which page sheet of the voice book is turned in so that the audio device will select the particular sound messages with respect to the content of that turned in page sheet.

U.S. Pat. No. 5,356,296 discloses an audio storybook that incorporates raised characters within the storybook, which are electronically connected to a sound synthesizer and reproduction apparatus associated with the book.

U.S. Pat. No. 5,413,486 presents an interactive book having a mechanism for generating a plurality of sensory outputs. The device requires separate function initiators corresponding to visual indicia printed on a book, and a user needs to look for a function initiator whenever he or she wants to get output for the visual indicia.

U.S. Pat. No. 4,884,974 discloses an interactive talking book and audio player. The device requires a ROM module attached to its back cover. Also, each page requires a special bar code.

U.S. Pat. No. 5,851,119 discloses an interactive storybook that requires a touch sensitive pad. The book is able to provide particular sounds corresponding to (X, Y) coordinates. The sensitivity of the touch sensitive pad might be limited.

In a system described by U.S. Pat. No. 5,466,158, the device comprises a base unit with a sensitive upper surface on which is placed the printed material. The reader answers questions and solves challenges posed in the printed material by exerting pressure on specially marked areas of the printed page. The sensitive surface translates the pressure into electrical signals which signify the location of the pressure, and the device makes appropriate audio or other responses.

Likewise, for a system described in U.S. Pat. No. 5,686,705, the system has a conductive material layer, over which a non-conductive skin having graphics printed thereon can be placed.

There is also a device using a digitizing tablet made of a wire grid.

In a system disclosed by U.S. Pat. No. 5,174,759, the use of ultrasonic positioning for identifying the position of a pointer over a page is disclosed. The system uses a frame where ultrasonic transducers are mounted in mutually perpendicular manner on both sides.

In a system disclosed by U.S. Pat. No. 7,085,693, the use of ultrasonic digitizers for simulation of a real tool over an off-line media is disclosed.

### BRIEF DESCRIPTION OF THE DRAWINGS

The disclosed embodiments are illustrated by way of example, and not by limitation, in the figures of the accompanying drawings, wherein elements having the same reference numeral designations represent like elements throughout, and wherein:

FIG. 1 is a schematic view that shows an exemplary, regular page of printed material;

FIG. 2 is a functional block diagram of a device in accordance with an embodiment of the present invention;

FIG. 3 is a schematic diagram that illustrates the principle of an ultrasonic positioning device in accordance with an embodiment of the present invention;

FIG. 4 is a block diagram of an ultrasonic positioning device in accordance with an embodiment of the present invention;

FIG. 5 is a schematic diagram that shows a data structure of response data in a data storage in accordance with an embodiment of the present invention;

FIG. 6 is a schematic view that shows an exemplary, regular page of printed material having a plurality of visual icons arranged for use with a method and a device in accordance with an embodiment of the present invention;

FIG. 7 is a block diagram of a response unit in accordance with an embodiment of the present invention;

FIG. 8 is a perspective view of an interactive book system in accordance with an embodiment of the present invention;

FIG. 9 is a schematic plan view of the interactive book system of FIG. 8;

FIG. 10 is a schematic view of an ultrasonic pointing unit in accordance with an embodiment of the present invention;

FIG. 11 is a schematic view of a wireless omni-directional ultrasonic pointing unit in accordance with an embodiment of the present invention; and

FIG. 12 is a schematic view showing an interactive book system using a wireless ultrasonic positioning unit in accordance with an embodiment of the present invention.

### DETAILED DESCRIPTION

“Visual icon” used herein refers to graph, text, picture, photo or any other objects that convey(s) visible information; a visual icon could be 2 or 3 dimensional.

“Printed material” used herein refers to books, magazines or other collections of sheets that contain visual icons.

“Data storage” used herein refers to any physical device that could store computer-readable data, such as, but not limited to, internal memory chips/cartridges (e.g., NAND flash memory, RAM, PROM, EPROM, FLASH-EPROM), removable, external memory cards (e.g., compact flash card, smartmedia card, secure digital card, multimedia card, etc.), optical disks (e.g., CD-ROM, DVD-ROM), magnetic media (e.g. hard drive, tape).

“Response data” used herein refers to data that responds to a reader/user's input. It could be data that represents perceptible output such as, but not limited to, vibration, sound, speech, music, light flashing (e.g., by LEDs—light emitting diodes), picture, video or motion emulation shown on a display (e.g., LCD—liquid crystal display), or control of internal components such as volume control, brightness control of the display, change of page, etc.

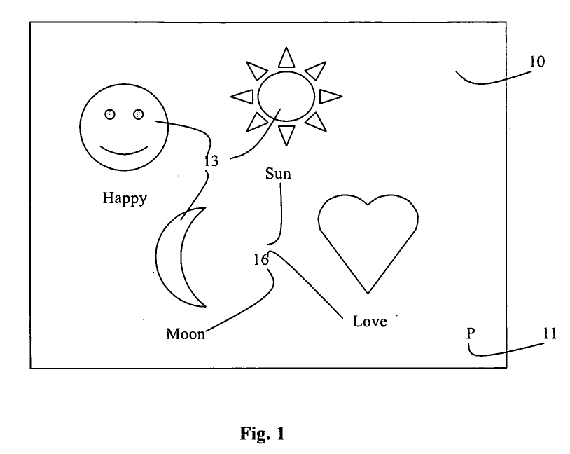

FIG. 1 is a schematic view that shows an exemplary, regular page 10 of printed material. On page 10, several visual icons, such as, graphics 13 and text 16 are provided. The page 10 is not interactive by nature, since it does not accept user input or produce output. An embodiment of the present invention is arranged to provide interactivity for a regular page, such as page 10, with intuitive usage, e.g., when a reader/user points at a visual icon like graphic 13 or text 16 or page number 11, a response would be immediately, or at least timely with no significant delay, given to the reader/user. A further embodiment of the present invention provides interactivity for a regular page without requiring special attachment of buttons or electronics to the page. Embodiments of the present invention are easier to use, more fun to use and cheaper to produce compared to the known devices.

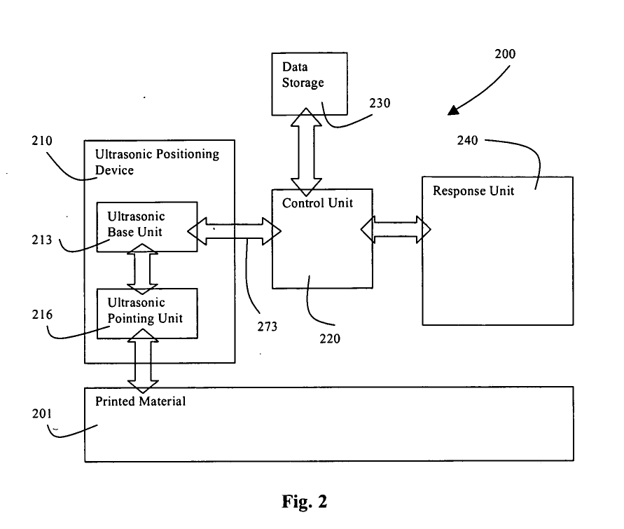

FIG. 2 is a functional block diagram of a device 200 in accordance with an embodiment of the present invention for use with printed material 201. In FIG. 2, the device 200 comprises an ultrasonic positioning device 210, a control unit 220, a data storage 230 and a response unit 240. Ultrasonic positioning device 210 further comprises an ultrasonic base unit 213 and an ultrasonic pointing unit 216. Ultrasonic pointing unit 216 is arranged for use by a user/reader to point at a visual icon on a regular page 10 of printed material 201 that he or she would like to interact with. Once said visual icon is pointed at, ultrasonic base unit 213 of ultrasonic positioning device 210 calculates the coordinate of ultrasonic pointing unit 216. Said coordinate is inputted to control unit 220 via interface 273. Based on said coordinate, control unit 220 searches for corresponding response data in data storage 230. Data storage 230 in accordance with embodiments of the present invention is accessible by control unit through one or more wired or wireless channels, e.g. data bus, USB port, RS-232 port, Bluetooth, 802.11b, Ethernet, etc. Said response data is returned to control unit 220 for processing, if necessary, and output via response unit 240. In another embodiment, the returned response data is used to control other components, such as volume and/or display controls of the response unit 240. Response unit 240 in an embodiment comprises a plurality of outputs, such as, but not limited to, one or more speakers for audible response data, one or more LEDs and/or LCDs for visual effects. The embodiments disclosed above provide an intuitive way for a user/reader to obtain a response when she or he points at a visual icon on a regular page of printed material. The embodiments disclosed above employ ultrasonic positioning device 210, without requiring a sensor board placed underneath the printed material as in the known devices, and thus make it more economical to accommodate large and thick printed material.

It should be noted that although in the embodiments disclosed above components such as ultrasonic positioning device 210, data storage 230 and response unit 240, are communicated via control unit 220, other arrangements are, however, not excluded. For example, in some embodiments, any component is communicable directly with any other component without the intermediary of control unit 220 which is either omitted or incorporated in one or more of the other components.

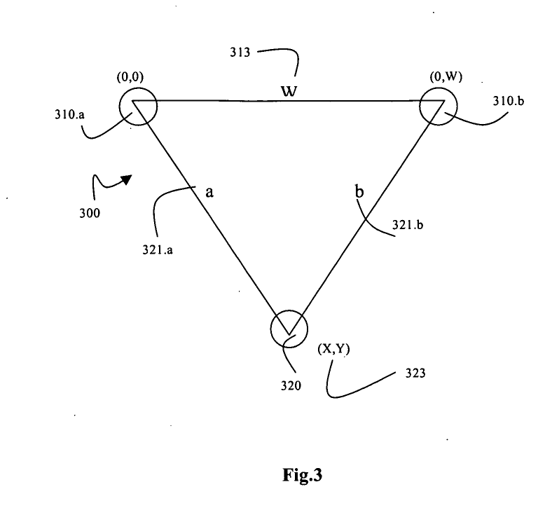

FIG. 3 is a schematic diagram that illustrates the principle of an ultrasonic positioning device 300 in accordance with an embodiment of the present invention. Ultrasonic positioning device 300 is usable as component 210 in device 200 described above and, like component 210, comprises an ultrasonic base unit and an ultrasonic pointing unit. The ultrasonic base unit includes a pair of ultrasonic transducers 310.a and 310.b located apart at a known distance “W” 313. The ultrasonic pointing unit includes an ultrasonic transducer 320. Given the measured distance “a” 321.a between transducers 310.a and 320, as well as the measured distance “b” 321.b between transducers 310.b and 320, the position of ultrasonic pointing unit, (X, Y) 323, is triangulated, either by the ultrasonic base unit or by another component such as control unit 220, using “W” 313, “a” 321.a and “b” 321.b. The same principle is applicable to the 3 dimensional space as well, although an additional transducer may be needed. It is a known and mature technique to measure distances using ultrasonic waves, e.g., by measuring time-of-flight of ultrasonic waves propagating between 2 or more ultrasonic transducers. A common technique is to measure time-of-flight by using a threshold.

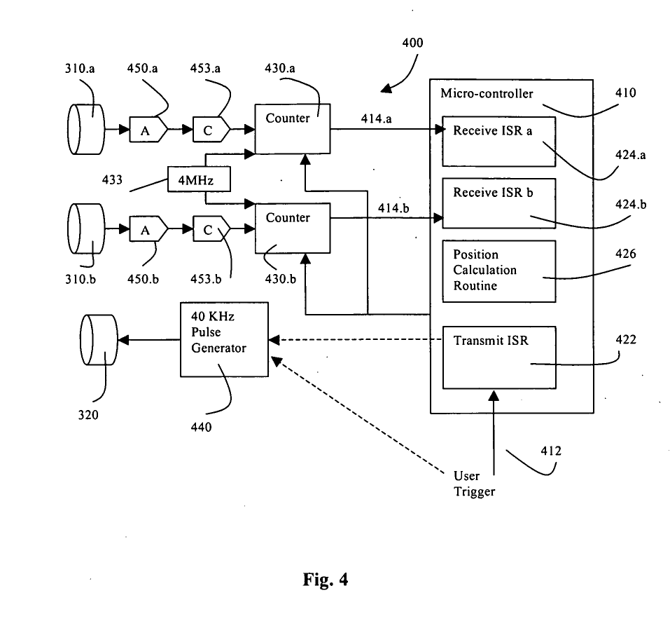

FIG. 4 is a block diagram of an ultrasonic positioning device 400 based on threshold measurement. The device 400 determines the arrival of an ultrasonic wave when it receives an ultrasonic signal at a level that exceeds a threshold. The threshold avoids wrong determinations if background noise exists. An oscillator 433 (in an embodiment, a 4 MHz crystal oscillator) clocks 2 counters 430.a and 430.b, which are initially reset to zero. When a user/reader points at a visual icon using ultrasonic pointing unit 216, an interrupt 412 to micro-controller 410 is triggered. Transmit interrupt service routine (ISR) 422 is invoked to serve the interrupt, which in turn triggers a pulse generator (in an embodiment, a 40 KHz pulse generator) 440 to produce a predetermined number (e.g., 20) of cycles of pulse. The pulses are converted to ultrasonic waves transmitted by ultrasonic transducer 320 of ultrasonic pointing unit 216. In the mean time, counters 430.a, 430.b are triggered to run according to the clock signal of oscillator 433. Said transmitted ultrasonic wave propagates until it is received by ultrasonic transducers 310.a, 310.b of ultrasonic base unit 213. Said received signals are amplified by stages of 450.a, 450.b, respectively, then compared against a threshold by comparators 453.a, 453.b, respectively. If the level of the amplified signal(s) exceeds said threshold, the respective comparator(s) 453.a, 453.b produce(s) a pulse or pulses which stop(s) the counters 430.a, 430.b, respectively. Interrupts 414.a, 414.b are issued by the counters 430.a, 430.b, respectively, to indicate their stops. Interrupt service routines 424.a, 424.b receive interrupts 414.a, 414.b, respectively, and read counters 430.a, 430.b, respectively. Counter values are converted to time by multiplying with the period of the clock signal of oscillator 433. Then, distance “a” 312.a between transducers 320 and 310.a is calculated by multiplying the obtained time with the sound speed. The distance “b” 312.b between transducers 320 and 310.b is calculated similarly. Position calculation routine 426 is invoked to calculate, by triangulation, the position (X, Y) 323 of ultrasonic pointing unit 216.

Other techniques for determining the position of ultrasonic pointing unit 216 are not excluded from the scope of the present invention. The disclosed embodiments have the ability to precisely determine the position of the ultrasonic pointing unit at least 1 meter in each direction from the ultrasonic base unit.

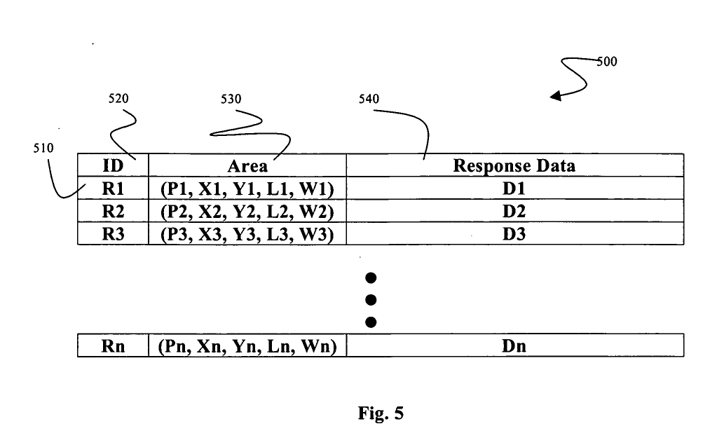

Once position (X, Y) 323 of ultrasonic pointing unit 216 has been determined, the determined position (X, Y) 323 serves as an input to control unit 220. Based on position (X, Y) 323, control unit 216 searches for response data corresponding to position (X, Y) 323 in data storage 230. In accordance with an embodiment of the present invention, FIG. 5 shows a data structure of response data in data storage 230. Data storage 230 contains a set of response data records 510, each response data record 510 comprising identifier 520, area descriptor 530, and response data 540. Identifier 520 is used to uniquely identify a response data record. Area descriptor 530 is used to define an area (e.g., a rectangle) occupied by or associated with a visual icon. Each area descriptor is represented as a vector (P, X′, Y′, L, W), where P denotes the page number of the printed material where the visual icon is provided, (X′, Y′) denotes the coordinate of a reference point, e.g., the upper-leftmost point, of the area, and L and W denote the dimensions, e.g., length and width, of said area relative to the reference point. An additional vector element or elements may be needed if 3-dimensional interactivity is desirable. Response data 540 is data that responds to user/reader's pointing at the respective visual icon. When control unit 220 receives position (X, Y) 323 of ultrasonic pointing unit 216, control unit 220 finds a response data record 510 with the associated area descriptor 530 that defines an area covering position (X, Y) 323. If such a response data record 510 is found, then control unit 220 retrieves the corresponding response data 540; otherwise, a default error response data is returned to control unit 220. Control unit 220 processes, if necessary, the retrieved response data 540, e.g., according to its type. For example, control unit 220 in an embodiment decodes ADPCM speech, MP3 music before direct the same to an audio output in response unit 240. The response data in another embodiment is processed by response unit 240.

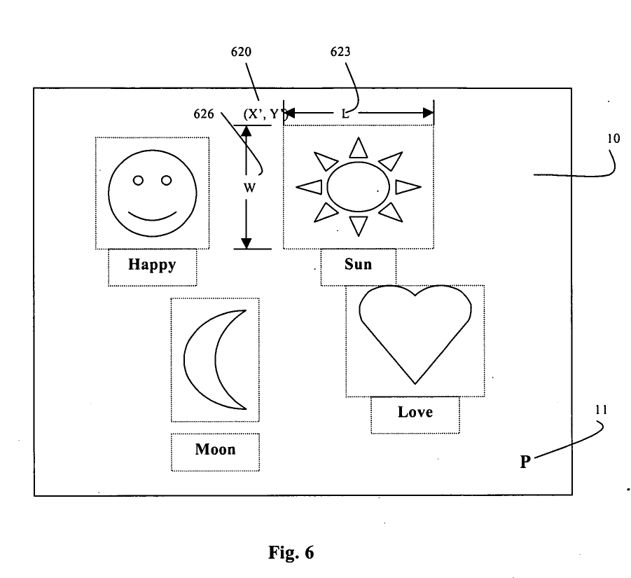

FIG. 6 is a schematic view that shows a regular page 10 having a plurality of visual icons. The area of each visual icon is approximated by a rectangle describing by page number P at 11, the coordinate of upper-leftmost point (X′, Y′) 620, length L 623, and width W 626. When a visual icon is pointed at using ultrasonic point unit 216, the associated rectangle is identified, and its associated response data 540 is retrieved. Thus, the use of the disclosed embodiments is intuitive with the “What you point at is what you get” capability.

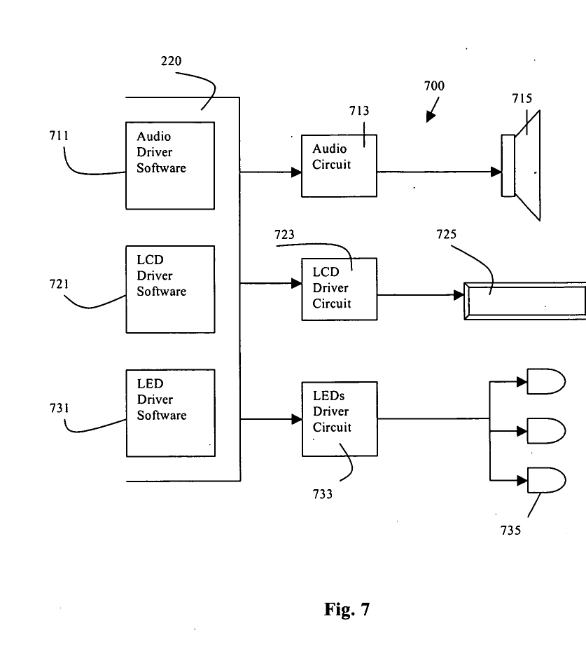

FIG. 7 is a block diagram of an embodiment 700 of response unit 240. An audio circuit 713 drives a speaker 715 for audio output. Control unit 220 implements audio driver software/programmed hardware/hardwire circuitry 711 to output audible response data to audio circuit 713. A display driver circuit, e.g., an LCD driver circuit, 723 drives a display, e.g., an LCD 725, for visual output. Control unit 220 implements LCD driver software/programmed hardware/hardwire circuitry 721 to output visual response data to LCD driver circuit 723. An LED driver circuit 733 drives an array of LEDs 735. Control unit 220 implements LED driver software/programmed hardware/hardwire circuitry 731 to output visual response data. With the sound produced by speaker 715, graphics or video shown on LCD 735 or flashing of LEDs 735, interaction with the printed material becomes an entertaining activity. It is within the scope of the present invention that response unit 240 need not include all of the above outputs and can include additional outputs, such as vibration. Other arrangements of the disclosed outputs are not excluded. For example, LED array 735 is arranged in an embodiment to function as a display for displaying, e.g., scrolling text, images etc.

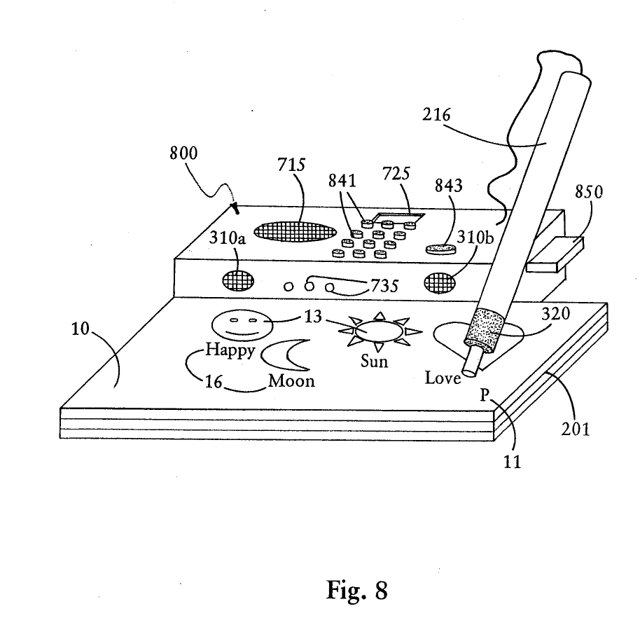

FIG. 8 is a perspective view of an interactive book system 800 in accordance with an embodiment of the present invention. Interactive book system 800 includes printed material 201. Printed material 201 comprises at least one page 10 on which several visual icons, e.g., graphics 13 and texts 16, are printed or otherwise provided. Interactive book system 800 further includes a ultrasonic positioning device 210 (not numbered on this Figure). Ultrasonic positioning device 210 further comprises an ultrasonic base unit 213 (not numbered in the figure) and an ultrasonic pointing unit 216. Ultrasonic pointing unit 216 has the shape of a pen or stylus, thus making it natural to use.

Ultrasonic base unit 213 further includes 2 ultrasonic transducers 310.a and 310.b. Ultrasonic pointing unit 216 further includes an ultrasonic transducer 320. Interactive book system 800 further includes a data storage, e.g., a memory card, 850 where response data 500 is stored. Memory card 850 is removable and replaceable, and is accessible by control unit 220 (not shown on this Figure) to retrieve response data 540. Interactive book system 800 further includes a keypad 841 for entry of user input, e.g., page number 11 or responses to questions generated by the system 800, and a power switch 843 for turning on or off the system. Interactive book system 800 further includes a response unit 240 (not numbered on this Figure) to output response date to a reader/user's input. Response unit 240 further comprises a speaker 715, LEDs 735, a LCD 725. Excluding printed material 201, interactive book system 800 in an embodiment is made in a 6″×3″×2″ form, and is arranged to work with printed material 201 as large as 24″×24″×1″ (e.g. a big book of maps) which size is not accommodable by the known devices.

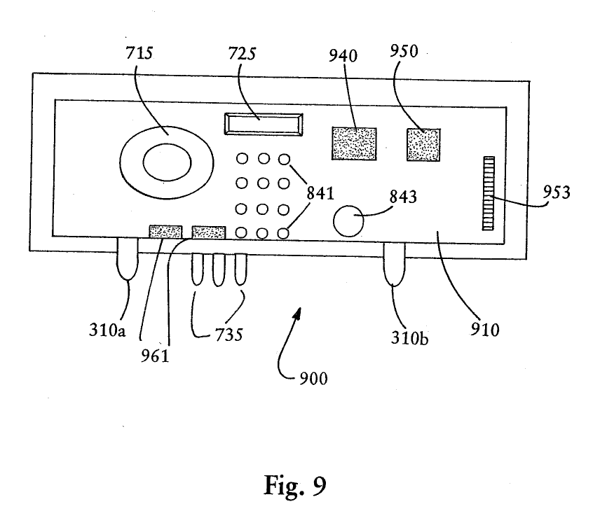

FIG. 9 is a schematic plan view of interactive book system 800. Components are mounted on a PCB schematically denoted at 910. Components invisible in FIG. 8 are shown in this figure. Microprocessor 940 is used in control unit 220. Micro-controller 950 is used in ultrasonic positioning device 210. There are ICs 961 for driving the speaker, LCD and LEDs. There is also a connector 953 for memory card 850. Since the number of components is relatively small, interactive book system 800 is relatively cheap to make.

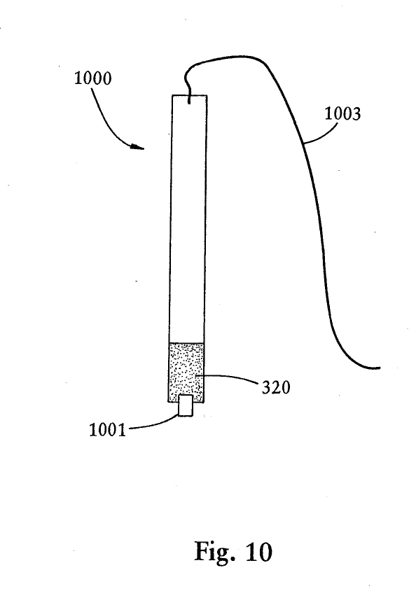

FIG. 10 is a schematic view of one embodiment 1000 of an ultrasonic pointing unit 216 used in interactive book system 800. Embodiment 1000 is a pen like unit with a tip 1001. In the embodiment shown in the figure, ultrasonic pointing unit 216 is attached and connected to micro-controller 410 of ultrasonic base unit 213 by a cable 1003 for transmitting a reader/user's triggering signal and receiving the subsequent pulse generation command as described with respect to FIG. 4. In particular, when tip 1001 is pressed, e.g., by the user/reader, against a visual icon on page 10 of the printed material, the pressed tip 1001 functions as a push button that activates a corresponding circuit (not shown) in the pen to trigger and send interrupt 412 sent along cable 1003 back to ultrasonic base unit 213 to start the counting of the counters 430.a, 430.b. Meanwhile, pulse generator 440 starts to generate pulses of a 40 KHz ultrasonic wave, either in response to the interrupt 412 when pulse generator 440 is in ultrasonic base unit 213 or directly in response to the user/reader's pressing of tip 1001 when pulse generator 440 is in ultrasonic pointing unit 216. The generated pulses are transmitted (through cable 1003 when pulse generator 440 is in ultrasonic base unit 213), as an ultrasonic wave, from ultrasonic transducer 320. The beam angle of ultrasonic transducer 320 is omni-directional, so that embodiment 1000 could be used with ease without careful orientation toward ultrasonic transducers 310.a, 310.b of ultrasonic base unit 213. Cable 1003 further serves to supply power to the circuitry inside the pen. Since embodiment 1000 is a pen like unit, interactive book system 800 is natural and intuitive to use.

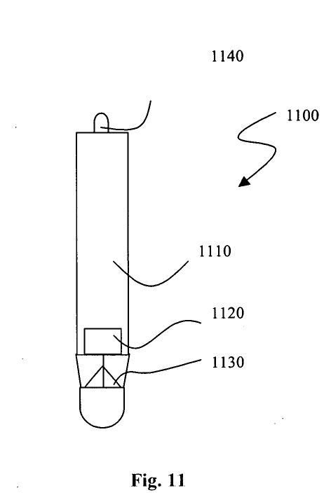

FIG. 11 is a schematic view of a wireless omni-directional ultrasonic pointing unit 1100 using a directional ultrasonic transmitter 1120 inside an ultrasonic pointing unit housing 1110 to transmit ultrasonic waves toward a reflective structure 1130. The transmitted ultrasonic wave is therefore reflected by the reflective structure 1130 to propagate the directional ultrasonic wave in an omni-directional manner. In addition, there are a power source (not shown), such as a battery or solar cell, and an infrared emitter 1140 to send user trigger signal 412 wirelessly to ultrasonic base unit 213. The pulse generator 440 is also provided in the pen.

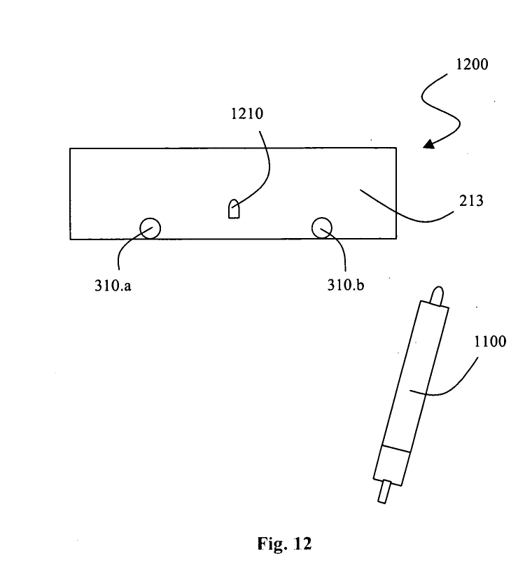

FIG. 12 is a schematic view of a wireless ultrasonic positioning unit 1200 for use with ultrasonic pointing unit 1100 in an interactive book system in accordance with an embodiment of the present invention. Specifically, user trigger signal 412 is sent wireless via infrared emitter 1140 toward an infrared receiver 1210 in ultrasonic base unit 213. The user trigger signal 412 triggers the calculation of (X, Y) coordinate 323 of ultrasonic pointing unit 216 as disclosed above. User trigger signal 412, in an embodiment, also includes encoded or uncoded information about the state of ultrasonic pointing unit 1100, for example, the type of ultrasonic pointing unit 1100, the battery state, as well as the state of any additional buttons and/or circuits on ultrasonic pointing unit 216. Besides infrared, other techniques for wireless communication, either unidirectional or bidirectional, between pen 1100 and ultrasonic pointing unit 216 are not excluded.

Operation

In accordance with an embodiment of the present invention, a method of interacting with printed material comprises following steps
Powering on a book interacting system, such as system 800, by using power switch 843 if the system is in a power-off state;
Positioning the printed material in a predetermined position relative to the transducers 310.a and 310.b and turning to a page, e.g., page 10, of the printed material;
Entering the page number by using keypad 841 or by pointing and pressing the system's ultrasonic pointing unit, such as 216, against page number P on page 10;
Selecting a visual icon on page 10 by using ultrasonic pointing unit 216;
Receiving response corresponding to the selected visual icon from one or more of the system's speaker(s), LEDs and LCD.

The use of the disclosed embodiments, especially system 800 is easy and intuitive. The system in accordance with embodiments of the present invention is compact and portable, and works with any properly designed printed material, including large size printed material, such as books of maps, as well as 3D objects. The system, when equipped with an omni-directional and wireless pointing unit, allows user/readers, especially young children, to easily interact with the printed material. The sounds and/or visual effects provided by disclosed embodiments of the present invention help engage readers to interact with contents provided by said printed material 201. It is particularly useful for language learning and/or storytelling, and makes reading a more entertaining process.

After reading the foregoing specification, one of ordinary skill will be able to affect various changes, substitutions of equivalents and various other aspects of the embodiments as disclosed herein. It is therefore intended that the protection granted hereon be limited only by the definition contained in the appended claims and equivalents thereof.

1. An interactive system for interacting with a printed material, said printed material comprising at least a visual icon associated with predetermined response data, the system comprising:
an ultrasonic pointing unit positionable over said at least one visual icon and comprising:
a first ultrasonic transducer, and
a reflective structure arranged for reflecting a unidirectional ultrasonic wave transmitted from said first ultrasonic transducer to create an omni-directional ultrasonic wave;
an ultrasonic positioning base unit comprising at least a second and a third ultrasonic transducers for receiving the omni-directional ultrasonic wave from the ultrasonic pointing unit and determining a position of the ultrasonic pointing unit based on the received omni-directional ultrasonic wave;
a control unit coupled to the ultrasonic positioning base unit for receiving the determined position and locating, in a data storage, the response data corresponding to said visual icon according to the position of said ultrasonic pointing unit; and
a response unit for outputting said response data.

2. The interactive system of claim 1, further comprising at least one of said data storage and said printed material.

3. An interactive system for interacting with a printed material, said printed material comprising at least a visual icon associated with predetermined response data, the system comprising:
an ultrasonic pointing unit positionable over said at least one visual icon and comprising a first ultrasonic transducer, and a trigger;
an ultrasonic positioning base unit comprising at least a second and a third ultrasonic transducers for receiving an ultrasonic wave from the first ultrasonic transducer and determining a position of the ultrasonic pointing unit based on the received ultrasonic wave;
a control unit coupled to the ultrasonic positioning base unit for receiving the determined position and locating, in a data storage, the response data corresponding to said visual icon according to the position of said ultrasonic pointing unit; and
a response unit for outputting said response data;
wherein the trigger is arranged for generating and sending, in response to user input, a trigger signal to the ultrasonic positioning base unit to trigger the determination of the position of the ultrasonic pointing unit.

4. The interactive system of claim 3, wherein said trigger is connected to the ultrasonic positioning base unit by a cable over which the trigger signal is to be sent to the ultrasonic positioning base unit.

5. The interactive system of claim 3, wherein said trigger is wirelessly communicable with the ultrasonic positioning base unit for wirelessly sending the trigger signal to the ultrasonic positioning base unit.

6. The interactive system of claim 5, wherein said trigger comprises an infrared emitter and said ultrasonic positioning base unit further comprises an infrared receiver for wirelessly receiving the trigger signal from said infrared emitter.

7. The interactive system of claim 3, wherein said trigger further comprises a tip which is pressable against the visual icon and in response to which the infrared emitter is caused to generate and transmit said trigger signal.

8. The interactive system of claim 3, wherein said trigger signal includes information regarding a state of the ultrasonic pointing unit.

9. The interactive system of claim 8, wherein said information is encoded.

10. The interactive system of claim 3, wherein said an ultrasonic pointing unit further comprises a reflective structure arranged for reflecting the ultrasonic wave transmitted from said first ultrasonic transducer to create an omni-directional ultrasonic wave to be received by the second and second transducers.

11. The interactive system of claim 3, further comprising at least one of said data storage and said printed material.

12. A method of interacting with a printed material, said printed material comprising at least a visual icon associated with predetermined response data, the method using a system for interacting with said printed material, said system comprising an ultrasonic pointing unit and an ultrasonic positioning base unit, said method comprising:
said ultrasonic pointing unit, in response to user's interaction therewith, generating an ultrasonic wave and sending a separate, trigger signal to the ultrasonic positioning base unit;
the ultrasonic positioning base, in response to receipt of said trigger signal, starting calculation of a position of the ultrasonic pointing unit based on the ultrasonic wave received separately from said trigger signal at said ultrasonic positioning base; and
outputting the response data in accordance with the calculated position of the ultrasonic pointing unit.

13. The method of claim 12, wherein said trigger signal is sent via a cable to the ultrasonic positioning base unit.

14. The method of claim 12, wherein said trigger signal is sent wirelessly to the ultrasonic positioning base unit.

15. The method of claim 12, wherein said trigger signal is sent by infrared to the ultrasonic positioning base unit.

16. The method of claim 12, wherein said user's interaction comprises pressing a tip of the ultrasonic pointing unit against the visual icon.

17. The method of claim 12, wherein said trigger signal includes information regarding a state of the ultrasonic pointing unit.

18. The method of claim 17, wherein said information is encoded.

19. The method of claim 12, further comprising
said ultrasonic pointing unit generating a unidirectional ultrasonic wave and then converting said unidirectional ultrasonic wave into an omni-directional ultrasonic wave for propagation to the ultrasonic positioning base unit.
